(19) United States
(12) Patent Application Publication
(10) Pub. No.: US 2010/0068531 A1
(43) Pub. Date: Mar. 18, 2010

(54) ELECTROMAGNETIC WAVE SHIELD WITH VACUUM DEPOSITED METAL USING WATER DISPERSED POLYURETHANE

(76) Inventors: Ja Eun Gu, Gyeonggi-do (KR); Ja Jung Koo, Gyeonggi-do (KR)

Correspondence Address: THOMPSON HINE L.L.P.;Intellectual Property Group, P.O. BOX 8801, DAYTON, OH, 45401-8801, US

(21) Appl. No.: 12/516,225

(22) PCT Filed: Nov. 29, 2007
(86) PCT No.: PCT/KR07/06080

§ 371 Date: Sep. 11, 2009

(30) Foreign Application Priority Data
Dec. 19, 2006 (KR) 10-2006-0129821

(51) Int. Cl. B32B 27/40; C08L 75/04

(52) U.S. Cl. 428/425.8; 524/589; 524/591

(57) ABSTRACT

There is provided an electromagnetic wave shield employing water-dispersed polyurethane. The electromagnetic wave shield comprises a plastic layer; a water-dispersed polyurethane primer layer formed on the plastic layer; and a metal deposited layer formed on the water-dispersed polyurethane primer layer. The electromagnetic wave shield has excellent surface property of a deposited metal and good durability through providing peeling resistance for a metal deposited layer by water-dispersed polyurethane.

### TECHNICAL FIELD

The present invention relates to a novel electromagnetic wave shield, and more particularly, to an electromagnetic wave shield for vacuum deposition employing water-dispersed polyurethane, in which a water-dispersed polyurethane composition is coated as a primer on a surface of a device, and a metal deposited layer is formed thereon for shielding an electromagnetic wave.

### BACKGROUND ART

Presently, electronic devices such as an electronic range, TV, a radio, a computer and a mobile phone emit much electromagnetic wave.

The emission of an electromagnetic wave occurs as a phenomenon such a noise or a communication error, and affects a human body. Concern about the electromagnetic wave shielding is growing and the need thereabout is increasing as the electromagnetic wave is more seriously recognized in the present day. Further, conventionally, a metal has been used as a device case; however, plastic is now used according to miniaturization of a device and increase in productivity. However, since plastic is electronically transparent, and thus electromagnetic waves are massively emitted therefrom, a measure therefor is urgently needed.

As ways for shielding an electromagnetic wave, metal spraying, vacuum deposition, plating and a conductive paint are employed, and recently, material such as conductive plastic is also actively developed.

A way employing a conductive paint has been widely employed since it is easy to handle and produce massively. Such conductive paint coating method comprises preparing a paint by employing a metal having a small diameter, and coating the paint to form a coat, as disclosed in Korean Patent Application No. 10-2000-0083111 and U.S. Pat. No. 4,518,524. However, such conductive paint coating method has a shortcoming in that the coat has a large surface resistance of 25 micron to 30 Ohm since metal particle is dispersed in a polymer for a paint, and thus a coat therefrom is not dense on a surface. Further, there has been a problem that an expensive metal such as silver is required in excessive amounts for increasing an effect of shielding an electromagnetic wave in a conductive paint.

Meanwhile, a method of shielding an electromagnetic wave by film coating a metal having excellent electric conductivity on a structure of an electronic device generating an electromagnetic wave (e.g., injection formed plastic mobile phone case) by vacuum deposition is introduced. However, there has been a problem that interface adhesiveness between a polymer resin, which is an injected material, and a metal layer coated thereon, which is a conductive film for shielding an electromagnetic wave, is weak. In order to solve the problem that the adhesiveness between a metal layer and an injected material is weak, a way of coating an acrylic resin or ABS resin, or UV curable paint as a primer, and then depositing a metal thereon has been developed.

Korean Patent No. 0387663 granted to Kyeong-Hee Lee discloses a method of enhancing the property of shielding electromagnetic waves by plating a metal on an engineering plastic not easy to perform electroless plating thereon. In more particular, an ABS resin and/or a UV curable paint were spray coated on the surface of an engineering plastic, not easy to perform electroless plating thereon, such as polybutylene terephthalate (PBT), polypropylene (PP), polyester (PE), polyamide (PA), acryl or a mixture of two or more thereof, thereby forming a primer layer, and then a dry plating such as electroless plating, vacuum deposition, sputtering and ion plating was performed. A substrate includes a polycarbonate (PC) resin or an engineering plastic not containing an ABS resin, and not easy to perform electroless plating thereon. A conductive laminate includes copper, nickel, chrome, gold and silver, etc. A primer material to improve binding force between a substrate and a conductive laminate is an applicable primer comprising an ABS resin and/or a UV (ultraviolet) curable paint. Thus, the patent discloses a method of providing the property of shielding harmful electromagnetic waves by coating a primer on a substrate, and then electroless plating. However, such ABS resin or UV curable paint has a shortcoming in that it is difficult to evenly coating on a plastic metal surface, and it is not easily adhered to the engineering plastic in solid state, and accordingly the adhesiveness of the metal layer formed thereon also becomes low.

Accordingly, a method of providing good adhesiveness and forming uniform film between a deposited metal layer and a lower resin layer is being developed. Korean Patent No. 0613140 granted to Polyscientech Inc. discloses a product that a composition for a primer layer comprising at least one polymer selected from a vinyl chloride based copolymer, polyester and polyurethane, polyisocyanate and an organic solvent is coated on a plastic substrate, and an organic silver composition is coated thereon. However, such method has a shortcoming in that much volatile organic solvent is exited during work since a strong organic solvent capable of swelling a primer layer is used in the organic silver composition and much organic solvent is also used in the primer layer.

Further, such method has a shortcoming in that the solvent contacts with a plastic case on coating the primer or the organic silver composition. If the plastic product contacts with the organic solvent, minute crack is generated in the plastic product, ESCR (Environment Stress Crack Resistance) is decreased, and thus crack is generated in the plastic during use.

Accordingly, a method of solving the problem of environmental pollution or inner environmental crack due to the use of an organic solvent is continuously needed.

### DISCLOSURE OF INVENTION

### Technical Problem

It is an object of the invention to provide an electromagnetic wave shield employing water-dispersed polyurethane.

It is another object of the invention to provide a method of manufacturing an electromagnetic wave shield employing water-dispersed polyurethane.

It is still another object of the invention to provide a composition for spraying water-dispersed polyurethane used in manufacturing an electromagnetic wave shield.

It is still yet another object of the invention to provide water-dispersed polyurethane used in manufacturing an electromagnetic wave shield.

### Technical Solution

In order to accomplish the above objects, according to one aspect of the invention, there is provided an electromagnetic wave shield comprising a plastic layer; a water-dispersed polyurethane primer layer formed on the plastic layer; and a metal deposited layer formed on the water-dispersed polyurethane primer layer.

In the above aspect of the present invention, the plastic layer constitutes an interior or exterior material of an electronic device, and can be preferably used irrespective of solvent resistance. In an embodiment of the present invention, the plastic layer is a product that a metal film layer is not formed without a primer layer, or the adhesiveness and peeling resistance of a formed film layer are weak, and a plastic product of which improvement in peeling resistance is required. In a preferable embodiment of the present invention, the plastic is polycarbonate, polymethyl methacrylate or a glass fiber used as material for a mobile phone case.

In the above aspect of the present invention, the water-dispersed polyurethane primer layer is manufactured by spray coating a water-dispersed polyurethane spray composition prepared by dispersing water-dispersed polyurethane in water so that a metal deposited layer may be uniformly coated on an upper surface, and the appearance characteristic of a coated surface may be improved. As the spray coating method, usual spray coating method can be used without any specific limitation.

In the above aspect of the present invention, the water-dispersed polyurethane spray composition comprises 20 to 80% by weight of water-dispersed polyurethane, 19.97 to 79.97% by weight of a water-dispersed medium, 0.01 to 5% by weight of a leveling agent, 0.01 to 5% by weight of a flow modifier and 0.01 to 5% by weight of a defoamer so that it may be suitable for spray coating method through which a metal deposited layer can be uniformly formed.

In the above aspect of the present invention, the leveling agent improves the leveling property of a surface to be sprayed, and various leveling agent can be used. In an embodiment of the present invention, the leveling agent is commercially available, and Flow-425 available at Tego Company can be used.

In the above aspect of the present invention, the flow modifier is introduced in order to improve the flow of water-dispersed polyurethane thereby reforming a surface, and various commercially available flow modifiers can be used. In an embodiment of the present invention, Glide #100 available at Tego Company can be used as the flow modifier.

In the above aspect of the present invention, the defoamer is used in order to suppress foaming in a water-dispersing agent to be sprayed, and Foamex #810 available at Tego Company can be preferably used.

In an embodiment of the present invention, the water-dispersed polyurethane spray composition can comprise a small amount of an alcoholic organic solvent for diluting the leveling agent, the defoamer and the flow modifier, and increasing the dispersibility with the water-dispersed polyurethane and the water-dispersed medium. In an embodiment of the present invention, a lower alcohol such as IPA, methanol and ethanol can be used in an amount of less than 5% by weight as the alcoholic organic solvent.

In the above aspect of the present invention, a caprolactone polyol, an ester polyol, an acryl polyol and a mixture thereof can be preferably employed for providing a metal layer to be deposited with improved peeling resistance as the water-dispersed polyurethane used in the water-dispersed polyurethane composition.

In an embodiment of the present invention, a caprolactone polyol containing carboxyl group can be more preferably employed for providing a metal layer to be deposited with improved peeling resistance as the caprolactone polyol.

In a preferable embodiment of the present invention, a caprolactone polyol containing carboxyl group is a polycaprolactone diol containing carboxyl group represented by Formula I below:

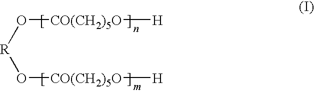

wherein n and m are an integer of 1 to 10, preferably 1 to 5, and R is a linear or branched C2-C10 alkyl containing —COOH group. In the present invention, a caprolactone polyol containing the carboxyl group is commercially available, and preferably n=2, and m=1, and R is Placcel 205BA available at Daicel Chemical Industries represented by formula below:

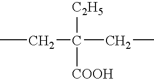

In a preferable embodiment of the present invention, a mixture in which usual polyether polyols are mixed while controlling water dispersibility and adhesiveness can be used as a caprolactone polyol containing the carboxyl group.

In the present invention, the polyester polyol prepared by reacting a polyol with an acid can be used. In a preferable embodiment of the present invention, the polyester polyol can be prepared by employing an ester polyol prepared by reacting a polyol such as ethylene glycol, neophentyl glycol and hexane diol with an acid such as isophthalic acid, adipic acid and azellic acid for providing a metal deposited layer with improved peeling resistance.

In another embodiment of the present invention, the acryl polyol is a polyol prepared by employing a compound selected from monomers having a hydroxyl group in vinyl form, e.g., 2-hydroxy ethyl acrylate, 2-hydroxy ethyl methacrylate, 2-hydroxy butyl acrylate and hydroxy propyl methacrylate, etc. A method of preparing the acryl polyol is disclosed in Korean Patent Application No. 10-1999-18863, and is also commercially available. Preferably, an acryl polyol available at Japan Soko Chemistry, having a molecular weight of 800 to 6000, more preferably 1000 to 3000 can be used.

In the present invention, the water-dispersed polyurethane can be prepared by employing a method in which a prepolymer formed by reaction of the polyol with polyisocyanate is neutralized, thereby extending chains.

In a preferable embodiment of the present invention, the polyurethane prepolymer is prepared by mixing a caprolactone polyol having a carboxyl group and a polyisocyanate with an organic solvent, and reacting in the presence of a catalyst, for example, a tin catalyst, e.g., dibutyltin dilauriate. As the organic solvent used in preparing the polyurethane prepolymer, a usual organic solvent known to the art, for example, benzene, toluene, ethyl acetate, acetone, methyl ethyl ketone, diethyl ether, tetrahydrofuran, acetic methyl, acetonitrile, chloroform, methylene chloride, carbone tetrachloride, 1,2-dichloroethane, 1,2,2-trichloroethane, tetrachloroethylene, and N-methyl pyrollidone, etc., can be used alone or a mixture thereof.

In another preferable embodiment of the present invention, the polyurethane prepolymer can be obtained by mixing polyester polyol, acryl polyol or a mixture thereof, and a compound having a carboxyl group, such as dimethyl propionic acid, with a polyisocyanate and an organic solvent, and reacting in the presence of a catalyst, for example, a tin catalyst.

In the present invention, the water-dispersed polyurethane prepolymer is obtained by dispersing a polyurethane prepolymer in water according to a conventional method. In a preferable embodiment of the present invention, the polyurethane prepolymer is reacted with triethylamine to be water soluble, and is chain-extended with a chain extender such as ethylenediamine, and thus is dispersed in water.

In the present invention, the metal deposited layer is prepared by using a conventional metal deposition method. In a preferable embodiment of the present invention, the metal deposited layer can be prepared by employing the method in which a metal is melted and deposited in vacuum, and the metal includes, but is not limited to, various forms such as silver, gold and aluminum.

According to another aspect of the invention, there is provided a product in which the water-dispersed polyurethane is used as a primer.

According to still another aspect of the invention, there is provided a method of manufacturing an electromagnetic shield comprising spray coating a water-dispersed polyurethane composition on a plastic substrate to form a primer; and depositing a metal on the spray coated layer.

### Advantageous Effects

According to the present invention, there is provided an electromagnetic shield in which a water-dispersed polyurethane primer layer is formed between a metal film layer and a base plastic for preventing a peeling phenomenon.

The electromagnetic shield according to the present invention is eco-friendly and is capable of preventing crack in a plastic product due to the use of an organic solvent since it uses water-dispersed type polyurethane capable of minimizing the use of an organic solvent by a polyurethane primer solution, and employs a non-solvent type metal deposited layer. The polyurethane primer according to the present invention can prevent a formed film from being peeled due to good adhesiveness with a metal film formed on its upper part.

### BEST MODE FOR CARRYING OUT THE INVENTION

The present invention will be described in greater detail with reference to the following examples. The following examples are for illustrative purposes only and are not intended to limit the scope of the invention.

### Examples 1 to 6

Preparation of a Polyurethane Prepolymer

A cooling apparatus, a thermometer, a stirrer and a mantle were prepared in 1 L cleaned 4-neck flask, and 406 g of polytetramethylether glycol (PTMEG) (MW: 2000), 105 g of Placcel 205BA (MW: 500), 0.5 g of dibutyltin dilauriate (DBTDL), 130 g of n-methyl pyrollidone (NMP) and 153 g of 4,4′-dicyclohexylmethane diisocyanate were poured into the flask, and reacted for 4 hours to provide a polyurethane prepolymer.

While 420 g of ion exchanged water, 12.3 g of triethylamine and 50 g of isopropyl alcohol were mixed in a separate 2 L beaker and agitated vigorously, 350 g of the polyurethane prepolymer prepared as above were poured slowly to solubilize in water. After vigorous agitation and solubilization in water for about 30 minutes, 80 g of ion exchanged water and 1.7 g of ethylene diamine were mixed and poured slowly, and after pouring and then vigorous agitation for about 20 minutes, the temperature was elevated to 70° C., and slow agitation was performed for 1 hour. After agitation, a water-soluble polyurethane resin with 32% solid content, pH 8.7 was obtained.

Deposition Test

Water-dispersed polyurethane prepared as above, a leveling agent, a flow modifier, a defoamer, an organic solvent and water were poured at ratios described in Table 1 below to provide a spray composition.

TABLE 1

| Item | Example 1 | Example 2 | Example 3 | Example 4 | Example 5 | Example 6 |
|---|---|---|---|---|---|---|
| Water | 20 | 30 | 40 | 50 | 60 | 70 |
| dispersed | | | | | | |
| PUD | | | | | | |
| Flow-425-20% | 0.5 | 0.5 | 0.5 | 0.5 | 0.5 | 0.5 |
| Foamex#810 | 0.1 | 0.1 | 0.1 | 0.1 | 0.1 | 0.1 |
| Glide#100-30% | 1.0 | 1.0 | 1.0 | 1.0 | 1.0 | 1.0 |
| IPA | 3.5 | 3.5 | 3.5 | 3.5 | 3.5 | 3.5 |
| Water | 74.9 | 64.9 | 54.9 | 44.9 | 34.9 | 24.9 |
| Total | 100 | 100 | 100 | 100 | 100 | 100 |

*Flow-425: Tego leveling additive. IPA.MeOH are diluted at 1:1 ratio to prepare in 20% concentration.
*Glide#100: Tego flow modifier additive. IPA.MeOH are diluted at 1:1 ratio to prepare in 30% concentration.
*Foamex#810: Tego defoamer
*IPA: isopropyl alcohol

The spray composition prepared as above was spray coated on the plastic side of polycarbonate material, and then the coated product was dried at 75° C. for 1 hour. After drying, the spray coated polycarbonate was put into a vacuum chamber, and then subjected to aluminum deposition at 70° C. for 1 hour.

Spray suitability, adhesiveness, gloss, leveling property, electric resistance, salt water resistance and crack resistance for the product prepared as above were tested.

The test results are summarized in Table 2 below.

TABLE 2

| Item | Example 1 | Example 2 | Example 3 | Example 4 | Example 5 | Example 6 |
|---|---|---|---|---|---|---|
| Spray | ⊚ | ⊚ | ⊚ | ⊚ | ⊚ | ⊚ |
| suitability | | | | | | |
| Gloss | ◯ | ◯ | ◯ | ◯ | ⊚ | ⊚ |
| Leveling | ◯ | ◯ | ◯ | ◯ | ◯ | ◯ |
| property | | | | | | |
| Electric | ⊚ | ⊚ | ⊚ | ⊚ | ⊚ | ⊚ |
| resistance | | | | | | |
| Adhesiveness | ◯ | ⊚ | ⊚ | ⊚ | ⊚ | ◯ |
| Crack | ⊚ | ⊚ | ⊚ | ⊚ | ⊚ | ◯ |
| resistance | | | | | | |
| Salt water | ⊚ | ⊚ | ⊚ | ⊚ | ⊚ | ⊚ |
| resistance | | | | | | |

⊚: very good,
◯: good
Δ: somewhat insufficient

### Comparative Example 1

A spray composition was prepared by employing the PUD prepared the same as in

Example 1 with ingredients at ratios described in Table 3 below, and the respective properties are summarized in Table 4.

TABLE 3

| | Comparative | Comparative |
|---|---|---|
| Item | example 1 | example 2 |
| Water dispersed PUD | 10 | 85 |
| Flow-425-20% | 0.5 | 0.5 |
| Foamex#810 | 0.1 | 0.1 |
| Glide#100-30% | 1.0 | 1.0 |
| IPA | 3.5 | 3.5 |
| Water | 84.9 | 9.9 |
| Total | 100 | 100 |

TABLE 4

| | Comparative | Comparative |
|---|---|---|
| Item | example 1 | example 2 |
| Spray suitability | ⊚ | Δ |
| Gloss | Δ | ⊚ |
| Leveling property | Δ | ◯ |
| Electric resistance | Δ | ◯ |
| Adhesiveness | Δ | ◯ |
| Crack resistance | Δ | Δ |
| Salt water resistance | Δ~◯ | ◯ |

⊚: very good, ◯: good, Δ: somewhat insufficient.

Vacuum depositing property for the spray composition prepared in Examples 1 to 6 and solvent type polyurethane was observed. Vacuum depositing property is totally observed for color reproduction, surface uniformity and gloss uniformity with naked eyes after forming a primer layer on a glass substrate and depositing silver thereon. The results are summarized in Table 5 below.

The solvent type polyurethane was prepared as below.

Cleaned 4 L flask, a stirrer, a mantle, a cooling tube and moisture separator were equipped, 229 g of ethylene glycol, 136 g of neopentyl glycol, 365 g of 1,6-hexanediol, 413 g of isophthalic acid, 363 g of adipic acid and 234 g of azellic acid were poured and 0.3 g of TBT (tributyltin) were poured, and when the temperature was elevated to around 130° C., melting and dehydration are slowly initiated. Then nitrogen is slowly added, and the temperature is continuously elevated to 250° C., and while maintaining 250° C., reaction is performed until acid value reaches below 0.1. After reaction is completed, a transparent polyester diol having average molecular weight of 3600 and acid value below 0.1 was prepared. 1750 g of polyesterdiol prepared as above, 593 g of ethyl acetate, 593 g of methylethyl ketone and 0.3 g of dibutyltin dilauriate were poured and stirred, and then 29.2 g of toluene diisocyanate were poured and reacted at 90° C. for 5 hours to provide a polyurethane resin having a solid content of 60% and a viscosity of 1500 cps.

30 parts by weight of the polyurethane resin prepared as above, 20 parts by weight of toluene, 15 parts by weight of ethyl acetate, 20 parts by weight of methylethyl ketone, 5 parts by weight of xylene and a polyisocyanate trimer having a solid content of 30% were poured as curing agents to prepare a polyurethane solvent type spray composition.

TABLE 5

| | Solvent | | | | | | |
|---|---|---|---|---|---|---|---|
| Item | type | Example 1 | Example 2 | Example 3 | Example 4 | Example 5 | Example 6 |
| After | X | ⊚ | ⊚ | ⊚ | ⊚ | ⊚ | ◯ |
| 75° C. × 10 min | | | | | | | |
| vacuum | | | | | | | |
| deposition | | | | | | | |
| After | Δ | ⊚ | ⊚ | ⊚ | ⊚ | ⊚ | ⊚ |
| 75° C. × 30 min | | | | | | | |
| vacuum | | | | | | | |
| deposition | | | | | | | |
| After | ⊚ | ⊚ | ⊚ | ⊚ | ⊚ | ⊚ | ⊚ |
| 75° C. × 60 min | | | | | | | |
| vacuum | | | | | | | |
| deposition | | | | | | | |

⊚: very good,
◯: good,
Δ: somewhat insufficient,
X: bad.

### Example 7

Cleaned 4 L flask, a stirrer, a mantle, a cooling tube and moisture separator were equipped, 229 g of ethylene glycol, 136 g of neopentyl glycol, 365 g of 1,6-hexanediol, 413 g of isophthalic acid, 363 g of adipic acid and 234 g of azellic acid were poured and 0.3 g of TBT (tributyltin) were poured, and when the temperature was elevated to around 130° C., melting and dehydration are slowly initiated. Then nitrogen is slowly added, and the temperature is continuously elevated to 250° C., and while maintaining 250° C., reaction is performed until acid value reaches below 0.1. After reaction is completed, a transparent polyester diol having average molecular weight of 3600 and acid value below 0.1 was prepared.

A stirrer, a mantle and a cooling tube were equipped in separate 1 L flask, 350 g of diol (molecular weight of 3600) prepared as above, 249 g of normal methyl pyrollidone and 39 g of dimethylol propionic acid were poured and stirred, and 208 g of isophorone diisocyanate and again 0.1 g of dibutyltin dilauriate were poured and reacted at 85° C. for 4 hours to provide a terminal NCO prepolymer having a solid content of 70.5%.

Then, 350 g of prepolymer were poured into a separate flask in the presence of 410 g of ion exchanged water and 8.9 g of triethylamine, and subjected to vigorous agitation and solubilization in water. Then, 63 g of ethylene diamine aqueous solution (5% in water) were poured, and chain extension was performed with vigorous agitating to prepare water-dispersed polyurethane.

### Example 8

170 g of ethylene glycol, 570 g of neopentyl glycol, 208 g of terephthalic acid, 138 g of isophthalic acid and 611 g of adipic acid were poured and 0.3 g of TBT (tributyltin) were poured, and when the temperature was elevated to around 130° C., melting and dehydration are slowly initiated. Then nitrogen is slowly added, and the temperature is continuously elevated to 250° C., and while maintaining 250° C., reaction is performed until acid value reaches below 0.1. After reaction is completed, a transparent polyester diol having average molecular weight of 1950 and acid value below 0.1 was prepared.

A stirrer, a mantle and a cooling tube were equipped in separate 1 L flask, 110 g of diol (molecular weight of 1950) prepared as above, 42 g of acrylpolyol (molecular weight of 1000) UMM-1001 (Japan Soko Chemistry), 37 g of dimethyl propionic acid and 210 g of normal methyl pyrollidone were poured and stirred, and 208 g of isophorone diisocyanate and again 0.1 g of dibutyltin dilauriate were poured and reacted at 85° C. for 4 hours to provide a terminal NCO prepolymer having a solid content of 65.4%.

Then, 350 g of prepolymer were poured into a separate flask while stirring in the presence of 352 g of ion exchanged water and 8.3 g of triethylamine, and subjected to vigorous agitation and solubilization in water. Then, 63 g of ethylene diamine aqueous solution (5% in water) were poured, and chain extension was performed with vigorous agitating to prepare water-dispersed polyurethane.

### Example 9

A stirrer, a mantle and a cooling tube were equipped in a cleaned 1 L flask, 384 g of acrylpolyol (molecular weight of 1000, Japan Soko Chemistry), 45 g of dimethyl propionic acid and 142 g of normal methyl pyrollidone were poured and stirred, and 196 g of isophorone diisocyanate and again 0.1 g of dibutyltin dilauriate were poured and reacted at 85° C. for 4 hours to provide a terminal NCO prepolymer having a solid content of 81.4%.

Then, 350 g of prepolymer were poured into a separate flask while stirring in the presence of 552 g of ion exchanged water and 8.3 g of triethylamine, and subjected to vigorous agitation and solubilization in water. Then, 63 g of ethylene diamine aqueous solution (5% in water) were poured, and chain extension was performed with vigorous agitating to prepare water-dispersed polyurethane.

### Comparative Example 3

A stirrer, a mantle and a cooling tube were equipped in a cleaned 1 L flask, 384 g of polypropylene glycol (molecular weight of 1000), 45 g of dimethyl propionic acid and 142 g of normal methyl pyrollidone were poured and stirred, and 196 g of isophorone diisocyanate and again 0.1 g of dibutyltin dilauriate were poured and reacted at 85° C. for 4 hours to provide a terminal NCO prepolymer having a solid content of 81.4%.

Then, 350 g of prepolymer were poured into a separate flask while stirring in the presence of 552 g of ion exchanged water and 8.3 g of triethylamine, and subjected to vigorous agitation and solubilization in water. Then, 63 g of ethylene diamine aqueous solution (5% in water) were poured, and chain extension was performed with vigorous agitating to prepare water-dispersed polyurethane.

Deposition Test

Water-dispersed polyurethane prepared as above, a leveling agent, a flow modifier, a defoamer, an organic solvent and water were poured at ratios described in Table 6 below to provide a spray composition.

TABLE 6

| | | | | Comparative |
|---|---|---|---|---|
| Item | Example 7 | Example 8 | Example 9 | example 3 |
| Example resin | 50 | 50 | 50 | 50 |
| Flow-425-20% | 0.5 | 0.5 | 0.5 | 0.5 |
| Foamex#810 | 0.1 | 0.1 | 0.1 | 0.1 |
| Glide#100-30% | 1.0 | 1.0 | 1.0 | 1.0 |
| IPA | 3.5 | 3.5 | 3.5 | 3.5 |
| Water | 44.9 | 44.9 | 44.9 | 44.9 |
| Total | 100 | 100 | 100 | 100 |

* Flow-425: Tego leveling additive. IPA•MeOH are diluted at 1:1 ratio to prepare in 20% concentration.
* Glide#100: Tego flow modifier additive. IPA•MeOH are diluted at 1:1 ratio to prepare in 30% concentration.
* Foamex#810: Tego defoamer
* IPA: isopropyl alcohol

The spray composition prepared as above was spray coated on the plastic side of polycarbonate material, and then the coated product was dried at 75° C. for 1 hour. After drying, the spray coated polycarbonate was put into a vacuum chamber, and then subjected to aluminum deposition at 70° C. for 1 hour.

Spray suitability, adhesiveness, gloss, leveling property, electric resistance, salt water resistance and crack resistance for the product prepared as above were tested.

The test results are summarized in Table 7 below.

TABLE 7

| | | | | Comparative |
|---|---|---|---|---|
| Item | Example 7 | Example 8 | Example 9 | example 3 |
| Spray | ⊚ | ⊚ | ⊚ | ⊚ |
| suitability | | | | |
| Gloss | ◯ | ◯ | ◯ | Δ |
| Leveling | ◯ | ◯ | ◯ | Δ |
| property | | | | |
| Electric | ⊚ | ⊚ | ⊚ | Δ |
| resistance | | | | |
| Adhesiveness | ⊚ | ⊚ | ⊚ | Δ-X |
| Crack | ⊚ | ⊚ | ⊚ | Δ |
| resistance | | | | |
| Salt water | ⊚ | ⊚ | ⊚ | Δ |
| resistance | | | | |

⊚: very good, ◯: good, Δ: somewhat insufficient, X: bad.

Although the present invention has been described with reference to several embodiments of the invention, the description is illustrative of the invention and is not to be construed as limiting the invention. Various modifications and variations may occur to those skilled in the art, without departing from the spirit and scope of the invention as defined by the appended claims.

1. An electromagnetic wave shield comprising a plastic layer; a water-dispersed polyurethane primer layer formed on the plastic layer; and a metal deposited layer formed on the water-dispersed polyurethane primer layer.

2. The electromagnetic wave shield according to claim 1, wherein the water-dispersed polyurethane primer layer is formed by spray drying a spray composition comprising water-dispersed polyurethane.

3. The electromagnetic wave shield according to claim 2, wherein the spray composition comprises water-dispersed polyurethane, a leveling agent, a flow modifier and a defoamer.

4. The electromagnetic wave shield according to claim 1, wherein the water-dispersed polyurethane is prepared by employing a polyol including a caprolactone polyol, a polyester polyol, an acryl polyol and a mixture thereof.

5. The electromagnetic wave shield according to claim 4, wherein the caprolactone polyol is a caprolactone polyol containing a carboxyl group.

6. The electromagnetic wave shield according to claim 4, wherein the polyester polyol is an ester polyol prepared by reacting a polyol selected from ethylene glycol, neophentyl glycol, hexane diol and a mixture thereof with an acid selected from isophthalic acid, adipic acid, azelic acid and a mixture thereof.

7. A polyurethane composition for spraying a metal deposited primer comprising 20 to 80% by weight of water-dispersed polyurethane, 19.97 to 79.97% by weight of water, 0.01 to 5% by weight of a leveling agent, 0.01 to 5% by weight of a flow modifier and 0.01 to 5% by weight of a defoamer.

8. The polyurethane composition for spraying a metal deposited primer according to claim 7, wherein the water-dispersed polyurethane is prepared by employing a polyol including a caprolactone polyol, a polyester polyol, an acryl polyol and a mixture thereof.

9. The polyurethane composition for spraying a metal deposited primer according to claim 8, wherein the caprolactone polyol is a caprolactone polyol containing a carboxyl group.

10. The polyurethane composition for spraying a metal deposited primer according to claim 8, wherein the polyester polyol is an ester polyol prepared by reacting a polyol selected from ethylene glycol, neophentyl glycol, hexane diol and a mixture thereof with an acid selected from isophthalic acid, adipic acid, azelic acid and a mixture thereof.
